(19) United States
(12) Patent Application Publication
(10) Pub. No.: US 2022/0108254 A1
(43) Pub. Date: Apr. 7, 2022

(54) System and Method for Measuring Service Performance

(71) Applicant: Richard Lightbown, Toronto (CA)

(72) Inventor: Richard Lightbown, Toronto (CA)

(21) Appl. No.: 17/065,422

(22) Filed: Oct. 7, 2020

(51) Int. Cl. G06Q 10/06; G06Q 10/10; G06Q 40/00; G06Q 50/22

(52) U.S. Cl. CPC G06Q 10/06393; G06Q 10/105; G06Q 40/12; G06Q 50/22; G06Q 10/06375; G06Q 10/063112; G06Q 10/063114; G06Q 10/101

(57) ABSTRACT

A method for measuring service performance of a company. The company may be a human services company. A performance technology system is provided for facilitating the method. The performance technology system enables human service providers to measure every change of every client in service to accurately reflect service performance and changes in the rate of service impact from period to period. By helping public and non-profit human service agencies to manage the impact of their services with clients in real time, the performance technology system enables them to increase the supply of services with available funding, and assure taxpayers and donors of measurable value for their money.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of human services of existing art and more specifically relates to a system and methods for measuring service performance of a human services company.

### RELATED ART

Human services help people in need of change in their lives. Helping people in need expresses inherent social value, and inherent social value drives the provision of billions in public and charitable funding each year to thousands of public and non-profit agencies big and small. Human services, however, remain in short supply. Thousands of people in need go without and thousands of others face wait lists and wait times. The gap between supply and demand widens with a growing, aging and increasingly diverse population.

Further, whilst agencies provide accounts and statistics that assure taxpayers and donors that their money is spent on services, the taxpayers and donors remain uncertain if $1 of funding buys $1, $10, or 100 in benefit for people in need. Impact remains uncertain. Agencies are unable to assure their funders that as many people as possible are achieving as many of the changes in their lives as possible with each $1 of funding. The inherent value of helping people is a constant, but the number and value of outcomes clients are achieving per $1 of funding remains unmeasured, varying constantly from period to period, agency to agency, and program to program. Thus, a need exists for a suitable solution.

### SUMMARY OF THE INVENTION

In view of the foregoing disadvantages inherent in the known human services art, the present disclosure provides a novel system and method for measuring service performance of a company. The general purpose of the present disclosure, which will be described subsequently in greater detail, is to provide the method and system for measuring service performance of a company, particularly a human services company. The system and method enables service providers to increase the supply of human services with available funding, thus saving on services.

A method for measuring service performance of a company and a performance technology system for facilitating the method is disclosed herein. The method may comprise the steps of: receiving base information, the base information including at least: staff information and financial information; receiving client information gathered from at least one client, the client information including at least: need information, goal information, and barrier information; determining at least one service plan for the at least one client; generating at least one client profile for the at least one client; receiving service information at predetermined intervals, the service information including at least: services rendered information, progress information, and outcome information; calculating baseline measures based on at least the base information; comparing at least the service information with the baseline measures; measuring service performance of the company in a current period based on comparison of the at least said service information with the baseline measures; and selectively generating at least one report illustrating service performance of the company in a selected period as tangible data.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a system and method for measuring service performance of a company, constructed and operative according to the teachings of the present disclosure.

FIG. 1 is a flow diagram illustrating a method for measuring service performance of a company, according to an embodiment of the present disclosure.

FIG. 2 is a schematic block diagram of a performance technology system, according to an embodiment of the present disclosure.

FIG. 3 is a schematic block diagram of the performance technology system of FIG. 2, according to an embodiment of the present disclosure.

FIG. 4 is a flow diagram illustrating a case management workflow, according to an embodiment of the present disclosure.

FIG. 5 is a flow diagram illustrating a workflow for bringing about changes for clients, according to an embodiment of the present disclosure.

FIG. 6 is a flow diagram illustrating a three-tier case management dataflow, according to an embodiment of the present disclosure.

FIG. 7 is a view of the performance technology system demonstrating a client profile, according to an embodiment of the present disclosure.

FIG. 8 is a table illustrating an example report, according to an embodiment of the present disclosure.

FIG. 9 is a table illustrating another example report, according to an embodiment of the present disclosure.

FIG. 10 is a bar chart illustrating another example report, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to human services and more particularly to a system and method for measuring service performance. The system and method may be used to improve the efficiency of services provided by a company, particularly a human services company (a company which provides human services). The system and method enables the human services company to measure rate of service impact per $1 of funding and increase the supply of human services with available funding, thus saving on services.

Generally disclosed is a performance technology system for human services. The performance technology system may enable human service providers to manage and measure the efficiency of use of resources in core service delivery processes in real time. The performance technology system may measure the Rate of Service Impact per $1 of funding continuously as services are delivered to people in need, enabling human service providers to help more people achieve more of the changes in their lives that they seek with every dollar of funding. By helping public and non-profit human service companies to manage the impact of their services with clients in real time, the performance technology system may enable them to increase the supply of services with available funding, and assure taxpayers and donors of measurable value for their money.

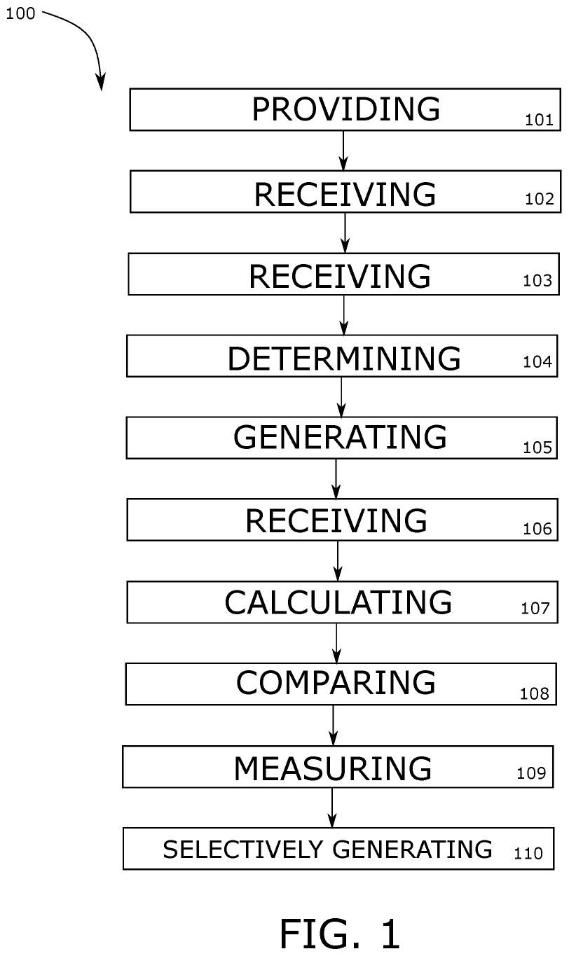

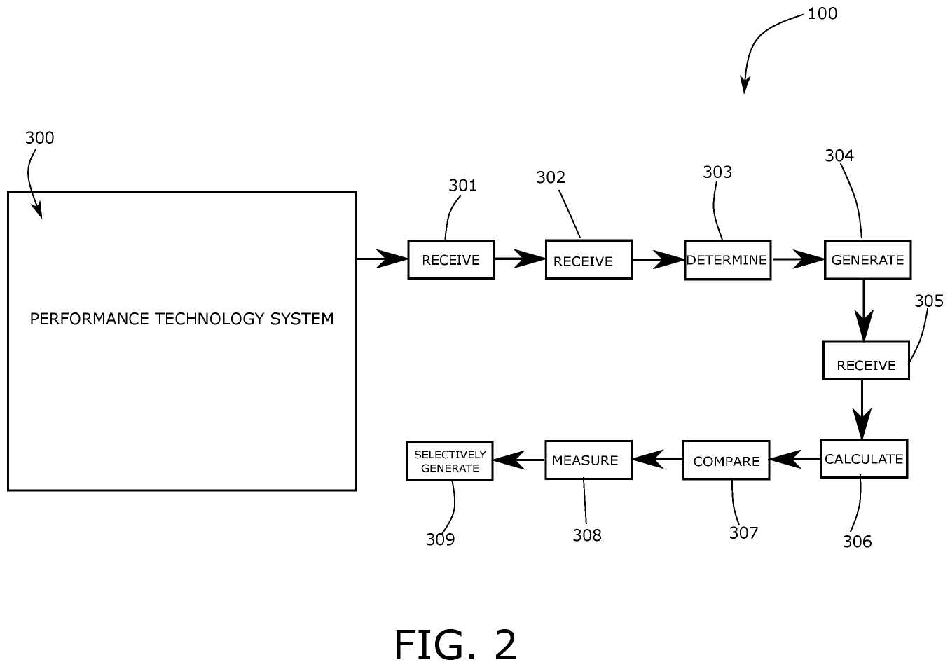

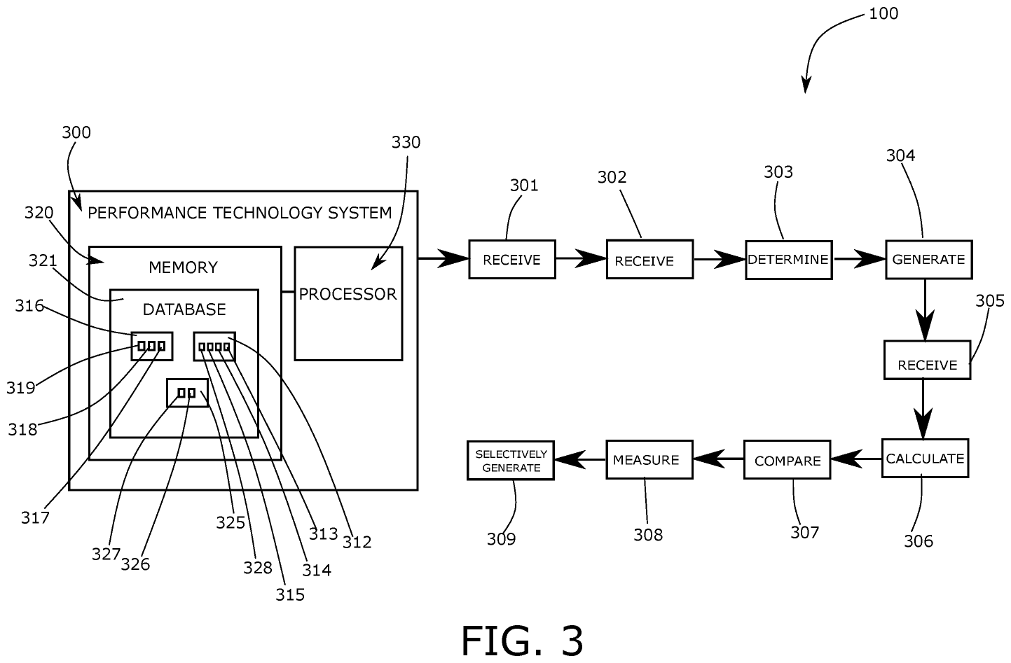

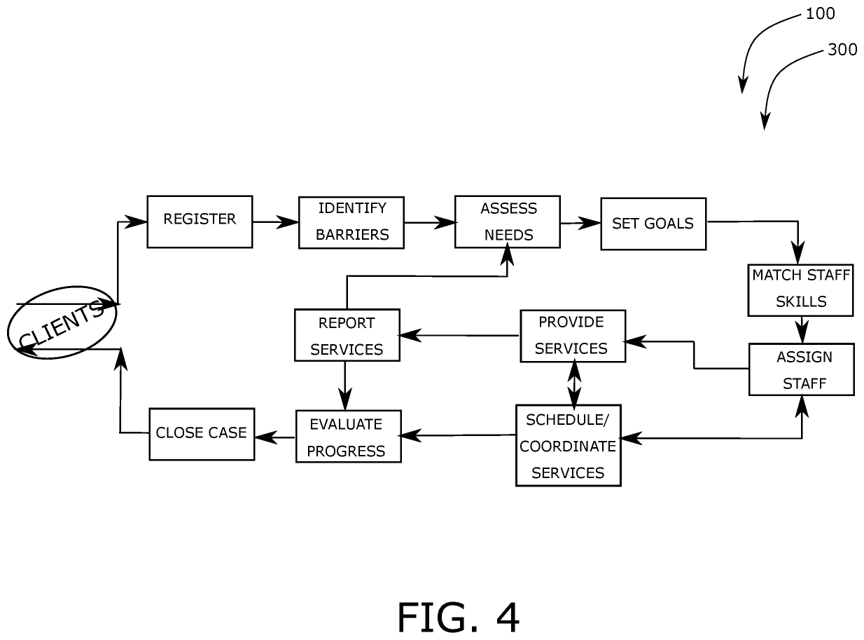

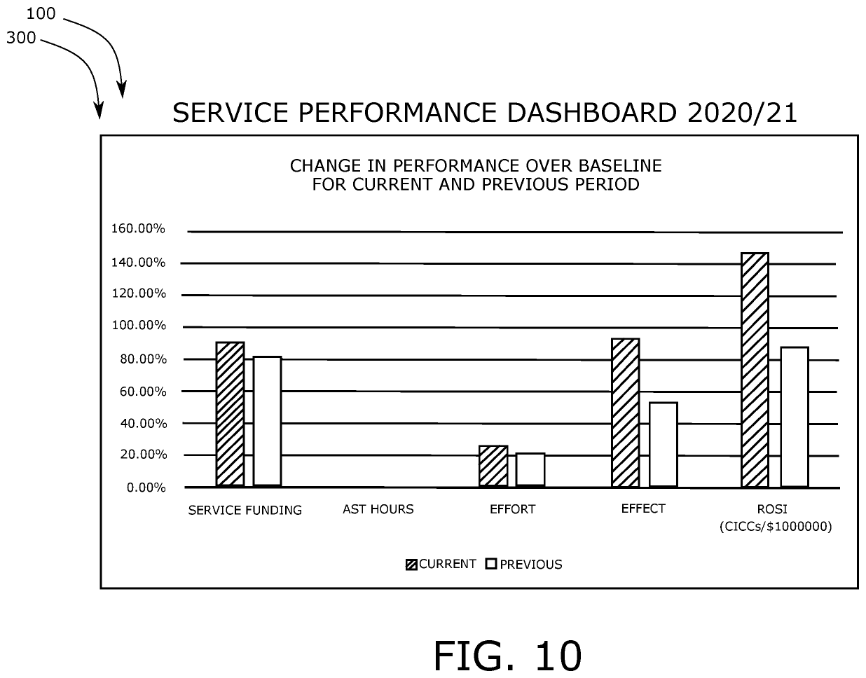

Referring now more specifically to the drawings by numerals of reference, there is shown in FIGS. 1-10, various flowcharts, block diagrams, bar charts and tables depicting methods and systems for measuring service performance of a company. A method for improving efficiency of services provided by a company 100 is disclosed herein. As shown, the method 100 may comprise the steps of: providing 101 a performance technology system 300; receiving 102 base information 325; receiving 103 client information 312 gathered from at least one client; determining 104 at least one service plan for the at least one client; generating 105 at least one client profile 328 for the at least one client; receiving 106 service information at predetermined intervals; calculating 107 baseline measures based on at least the base information 325; comparing 108 at least the service information 316 with the baseline measures; measuring 109 service performance of the company in a current period based on comparison of at least the service information 316 with the baseline measures; and selectively generating 110 at least one report illustrating service performance of the company in a selected period as tangible data. In a preferred embodiment, the method may be used for improving efficiency of services provided by a human services company.

The performance technology system 300 may analyze base service data on the fly to measure service performance as it happens. The base service data may include clients, needs, goals, contacts, time, scores, etc. The performance technology system 300 may set baseline performance measures and compare current period with baseline measures to gauge changes in performance from period to period. The performance technology system 300 may inform service providers with measures, enabling closer management of the use of resources in service delivery processes.

The performance technology system 300 may be accessible via an electronic device. For example, members of the company, such as managers, case managers and staff, may download or access the performance technology system via a smartphone, a laptop or desktop computer, a tablet computer, and the like. The performance technology system 300 may further include verification and security steps to prevent security breaches and protect the clients, as well as the companies, information. The performance technology system may include at least one memory 320 including at least one database 321; and at least one processor 330.

In this embodiment, the at least one processor 330 may be configured to perform steps 2-10 from method 100. For example, the at least one processor 330 may be configured to receive 301 base information 325; receive 302 client information 312 gathered from the at least one client; determine 303 at least one service plan for the at least one client; generate 304 at least one client profile 328 for the at least one client; receive 305 service information 316 at predetermined intervals; calculate 306 baseline measures based on at least the base information 325; compare 307 at least the service information 316 with the baseline measures; measure 308 service performance of the company in a current period based on comparison of at least the service information 316 with the baseline measures; and selectively generate 309 at least one report illustrating service performance of the company in a selected period as tangible data.

The methods and system disclosed may include a three-tier system. The at least one client may be registered into the performance technology system 300 when they are received by the company. This step may be performed by the case manager. This may be a first tier of the three-tier system, whereby client assessments are registered and data is recorded in the performance technology system 300. The first-tier data-processing may ensure user entry of complete service data for measuring cost of every change in client of every client in service. Case managers may assess a clients' needs for service. A record of client-specific needs for help may be composed by selection from a standardized spectrum of client needs specific to each program of human services. The severity or strength of each client's need for help may be scored numerically to differentiate service priorities. In addition, the case managers may set goals for change in relation to each need. A record of client-specific goals for change may be composed by selection from a standardized spectrum of client goals specific to that program.

Client information 312 gathered from the at least one client may be entered into the performance technology system. Particularly, the client information 312 may include need information 313, goal information 314 and barrier information 315. The need information 312 may include at least one need of the client and the goal information 314 may include at least one goal of the client, as established by the case manager in their assessment of the client. Preferably, the goal information 314 may include more than one goal of the client in reaching their need. Each goal may be scored numerically to distinguish priority for service in the list for each client.

Case managers may help clients to identify the client's barriers to their ultimate goal. As such, the barrier information 315 entered may include at least one barrier to achieving the at least one goal. In some cases, there may be multiple barriers to one or multiple goals and as such, the barrier information 315 and the goal information 314 may include this. The case managers may work with clients identifying their particular barriers to achieving the program, or ultimate goal for which they are seeking help, like regaining regular employment. These discussions may be client-specific, making up the content of narrative records, and clarifying the needs for help of the client.

As discussed above, assessment of the client may be composed by selection from a standardized spectrum and used in assessing needs, setting goals and evaluating progress to assure reliable aggregation of data. In some embodiments, the standardized records may be stored on the performance technology system 300. As such, one of the base information 325, client information 312 and service information 316 may include standardized scores and standardized phrases. This may allow the performance technology system 300 to aggregate data to enable it to perform calculations. Preferably, the base information 325 may include staff information 326 and financial information 327. The financial information 327 may include current funding or profit numbers, baseline funding or profit numbers, baseline costs for a certain period (such as monthly, quarterly, yearly, etc.). The staff information 326 may include current analysis of staff data, which may be used in matching staff skills and assigning staff by client goal.

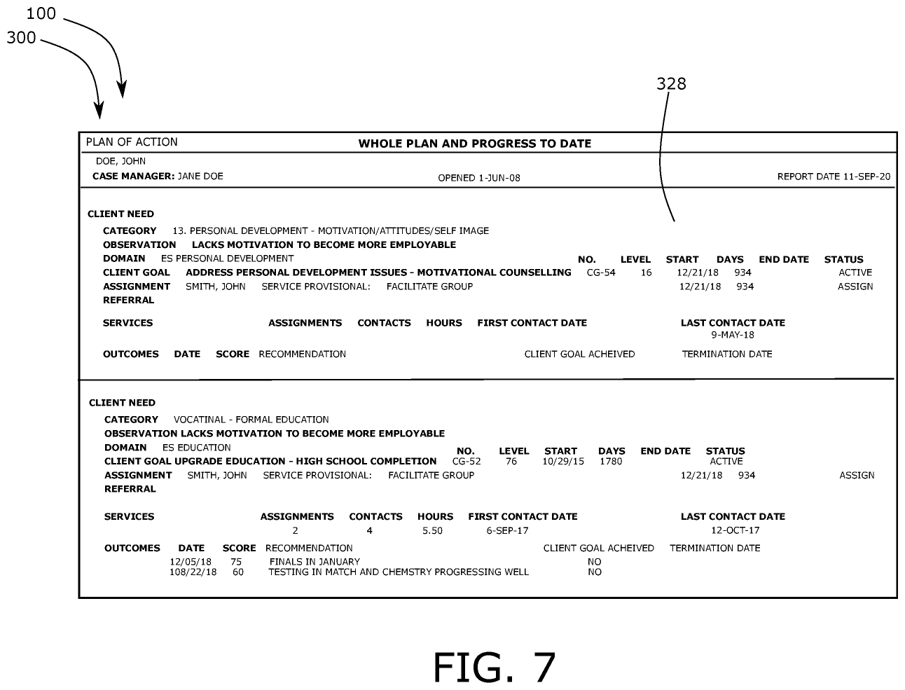

The at least one service plan may be determined based on the client information 312. The service plan may preferably be determined by the performance technology system 300 upon receipt of the client information 312. As above, the performance technology system 300 may be accessible via the electronic device. As such, the at least one database 321 may be viewable on the electronic device. Preferably, the at least one client is a plurality of clients, and each of the plurality of clients may have a client profile 328 (as shown in FIG. 7). Each client profile 328 may be stored on at the at least one database 321, and viewable on the electronic device. This may allow service providers to view each client in service holistically with respect to service provision at any given time.

Further, case managers and service providers may work from a view of their current caseload. In this embodiment, the at least one database 321 may include a caseload profile for each case manager or service provider. The caseload view may summarize client needs, goals, services and progress-to-date by each client in the assigned caseload. This caseload view may be included as a part of the client profile 328. In some embodiments, the clients be able to view at least a part of their client profile 328 on their own electronic device. In other embodiments, the client profile 328 may be exclusively managed by the company. Case managers and service providers may work on changes in case records from a view of each client's Plan of Action, showing set goal(s) by need, staff assigned by goal, referrals to external services by goal, services rendered by staff by goal, and reviews of client progress by goal. These views may enable case managers to manage three or four hundred client goals in a typical caseload of 25 to 40 cases at any point in time. The progress of clients in service may be recorded by case managers from period to period in regular case reviews with each client. Each goal-in-service may be reviewed and scored for percentage of completion.

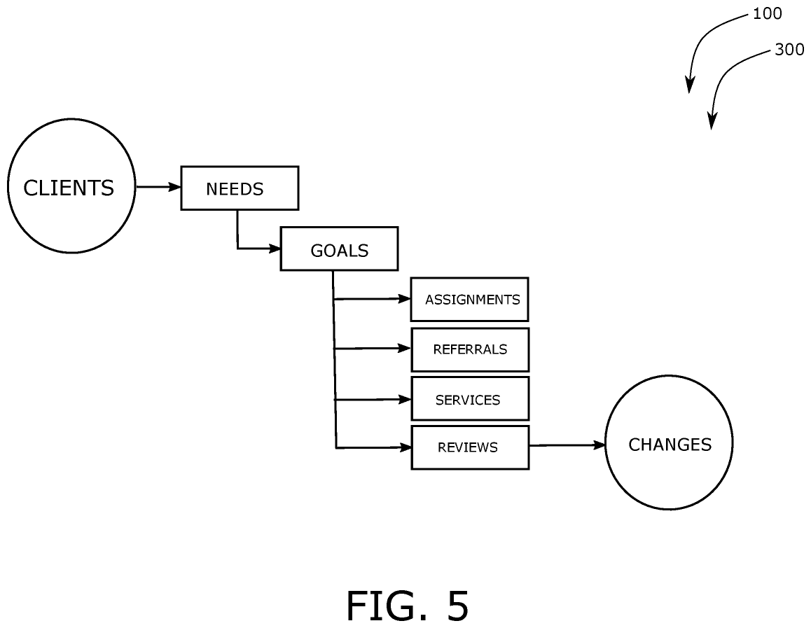

As illustrated in FIG. 5, the performance technology may support client-centered services, tracking every change of every client in service, from client-specific needs, to needs-specific goals, to goal-specific service assignments and referrals, to goal-specific services rendered to each client, to goal-specific reviews of client progress, to client-specific changes, in goal achievements, in service, as illustrated in FIG. 5. Client progress may include the count of client-specific goals achieved by individual clients in service, including intermediate and ultimate changes in the client's life.

When the service plan is established, the case managers may match staff skills to client goals and assign staff to work with clients on their needs and goals. The staff information 326 may include staff skill information and staff experience information for each staff member of the company; staff pay information; staff hours information; etc. In some embodiments, the staff information 326 may be compared with the client information 312, and a staff member may be recommended for the service plan based on comparison of the staff information 312 with the client information 312. Preferably, the performance technology system 300 may perform the recommendation, and the case manager may assign the staff members based on the recommendation. Over time, each services staff may build a profile of client goals ordered by the staff member's individual rate of success in helping the client achieve that goal. Inventory of services staff may be differentiated by goal/success rates of each staff member and may be updated continuously from records of progress and achievement of clients served by individual practitioners. Assigning of staff particularly skilled or experienced in an area suited to a clients' particular need/goal/barrier may make services more effective, thus reducing hours needed to create an outcome.

The service information 316 may include services rendered information 317, progress information 318 and outcome information 319. The progress information 318 may include the progress of the at least one client in reaching the at least one goal. The outcome information 319 may include an outcome in the service plan of the at least one client. Preferably, the progress information 318 and the outcome information 319 may be collected at predetermined intervals. The predetermined intervals may be from period to period. For example, there may be four periods each year, representing each quarter of the year. This may be recorded by assigned staff members or case managers. The case managers may further refer clients to external services when internal services are inappropriate to client's needs, schedule and coordinate service provision, and review and evaluate client progress in service on each of their goals from period to period.

Human services currently measure service performance in service outputs (client contacts and hours) and outcomes (client changes). Service measures, however, do not take account of the use of resources to produce them. Only productivity measures can assure public and private funders of human services of value for money. For example, increasing the production of 100 outcomes with $1 million in funding to 200 with $2 million is not a performance change. There are twice as many outcomes, but they each still cost $10,000. Introducing productivity measures (Rate of Service Impact [RoSi], Value of Service [VoS], and Return on service [RoS]) distinguishes productivity change from measurable change. In the example, above, changes in funding can change the number of client outcomes, directly and proportionately, if productivity rates remain constant. But RoSi is a key performance indicator that measures change in performance/productivity, as does VoS and RoS. The performance technology system 300 may utilize a set of standard terms (RoSi, VoS and RoS). The terms may be used for measuring performance in services, particularly human services, and the value created by companies that improve service performance. The RoSI may include the measure of a service company's ability to turn funding into client outcomes. While the outcomes that clients achieve differ from one kind of service to another, every human service company may produce service impact, the rate of client outcomes per $1 of funding. Productivity is measured program by program. One service provider, for example, may provide child protection services, family support (prevention) services, and children's mental health services. They are each distinct programs of service with different outcomes.

Productivity is measured using the key performance indicators, RoSi, VoS, and RoS, program by program in “every company”. Every program of every company has a baseline RoSi and every company may increase their RoSi, from period to period. By improving RoSi, companies create value. The outcome information 319 may include base outcome information. The base outcome information may be combined with at least a portion of the base information 325 to determine a baseline Rate of Service Impact. Further, the outcome information 319 may include current outcome information. The current outcome information may be combined with at least a portion of the services rendered information 317 to determine a current Rate of Service Impact. The Rate of Service Impact (RoSi) is the number of client outcomes per $1 of funding. The at least one processor 330 may be configured to calculate RoSI including baseline and current; VoS; and RoS. This may be at least part of a second tier of the three-tier system. On demand, the at least one processor 330 may further be configured to create a report reflecting the same. This may be at least part of a third tier of the three-tier system.

For example, a company that improves service performance from 100 to 150 client outcomes per $1 million in funding, adds $500,000 per $1 million in funding with each additional 50 outcomes achieved by clients in service. Changes in a company's RoSI measure changes in the value of service (VoS) and return on service (RoS) funding. Increasing RoSI by 50% creates VoS of $5000,000 per million in funding, and RoS of 500 per $1 of funding. Changes in RoSI add or subtract VoS. This example increased RoSI by 50%, reducing the cost per client outcome from $10,000 to $6,667. If the cost per outcome had instead increased from $10,000 to $13,333, RoSI may have decreased by 25%, producing 75 instead of 100 client outcomes per $1 million in funding. The RoS, observed above, of 500 per $1 of funding, would become minus (250) per $1 of funding. Changes in RoS, over baseline, from period to period may inform taxpayers and donors of the changing value in client outcomes created with their money.

The performance technology system 300 may enable human service providers to measure every change of every client in service, from which the service performance system can accurately measure changes in the RoSI from period to period. Valid measures of RoSI from period to period for any human service company may require the measure of every change of every client in service. People reach out for help to restore good health, regain employment, reunite family, and many other goals. Each person has their own mix of barriers to overcome, and each of them maps their own particular pathway to their ultimate goal with a variety of intermediate goals like: completing a GED, renewing a license, completing court orders, controlling an addiction, refreshing job skills, acquiring work experience, restoring self-esteem, repairing relationships, learning life skills, and many more. Achieving each of these client-specific goals represents a change in client condition (CiCC) and a step along the pathway to their ultimate goal. To measure every change of every client requires a detailed, client-specific plan of services for every client in service, prepared by a case manager working with the client, and executed by one or more service providers enabling clients to achieve the particular changes in their lives that they seek.

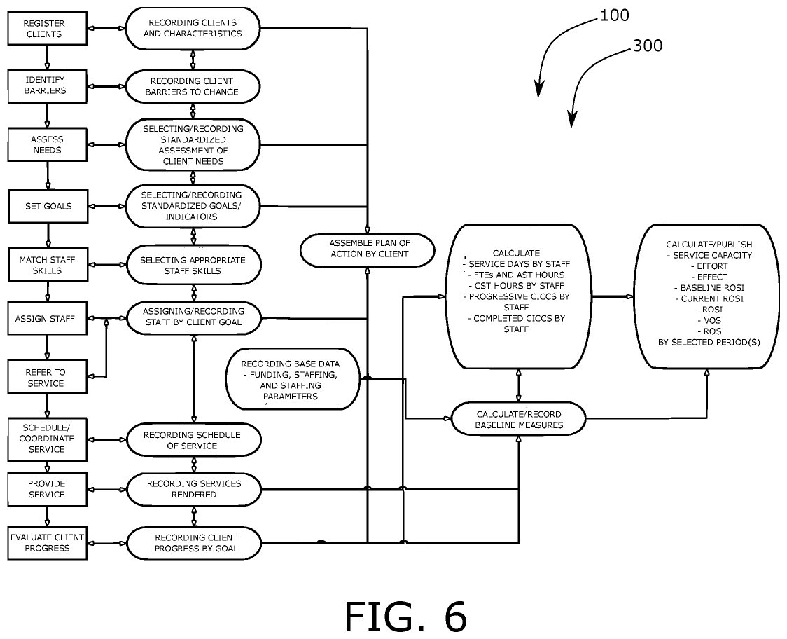

As above, the method and system may include a three-tier system. The three tier-system is illustrated in FIG. 6. As shown, in the first tier, the case manager/staff may register clients, and record clients and characteristics in the performance technology system 300; identify barriers and record client barriers in the performance technology system 300; assess needs and select/record standardized assessment of client needs in the performance technology system 300; set goals and select/record standardized goals/indicators in the performance technology system 300; match staff skills and select appropriate staff skills in the performance technology system 300; assign staff and assign/record staff by client goal in the performance technology system 300; refer to service; schedule/coordinate service and record schedule of service in the performance technology system 300; provide service and record services rendered in the performance technology system 300; evaluate client progress and record client progress by goal in the performance technology system 300. The case manager/staff may assemble the service plan, and record the base information which may include funding, staffing and staffing parameters in the performance technology system 300.

In the second tier, the performance technology system 300, preferably via the at least one processor 330 may calculate at least: service days by staff, Full Time Equivalents (FTEs) of services staff, and Available Service Time (AST) hours of services staff, Client Service Time (CST) hours rendered by staff, and progressive Changes in Client Condition (CICCs) achieved by clients with the help of staff; and completed CICCs enabled by staff. In this tier, the performance technology system 300 may also calculate and record baseline measures. The performance technology system 300 may do this at prescribed intervals. Further, as shown, in a third tier the performance technology system 300 (again, via the at least one processor 330) may calculate/publish productivity measures from tier one service data, and Baseline and Current RoSi, VoS, and RoS by selected periods. The performance technology system 300 may do this on scheduled intervals, or on demand (for example, if actuated by a user).

Whilst the human service company is the preferred embodiment, it should be appreciated that methods and systems included in the present disclosure are also contemplated for any type of funded service company. Improving service performance reduces the rate of use of company resources, of funding and staffing, to enable clients to achieve the changes in their condition they seek. The available resources of human service companies, measured in funding dollars and staff FTEs, change continuously from period to period, and within periods. While changes in available funding and staffing result in corresponding changes in client outcomes, they do not change service performance.

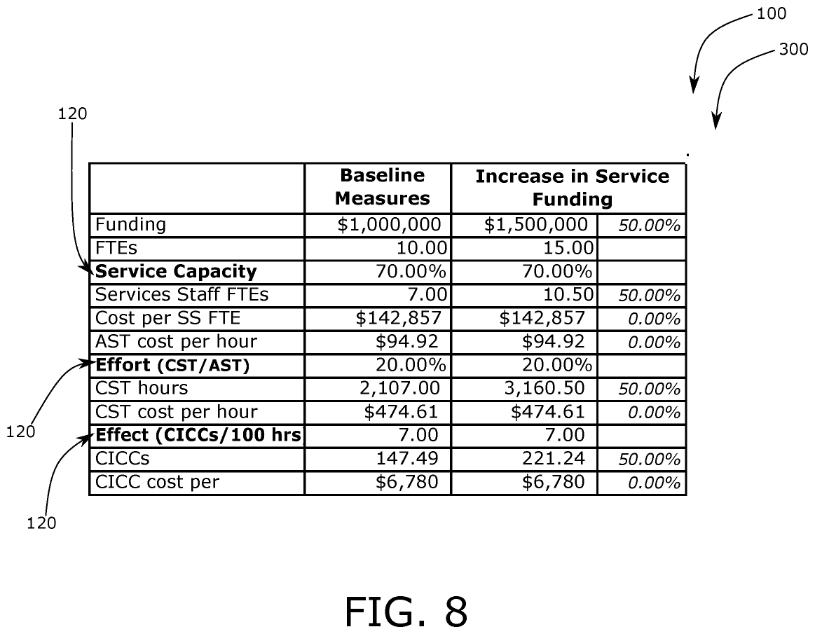

To manage service performance, companies need to be able to make changes in service delivery processes that they can see will result in changes in their bottom line, RoSi, VoS, and RoS. Improvements in service performance may reflect, separately or together, changes in three core business processes in human services, reflecting three key performance indicators. As such, the service performance may be measured relative to at least three key performance indicators 120. The at least three key performance indicators 120 may be: Service Capacity, Effort, and Effect. The at least one processor 330 may be configured to calculate the Service Capacity, Effort, Effect and create a report reflecting the same. FIGS. 8-10 show examples of such reports.

Service Capacity (or Service Funding) may involve converting funding into staff resources. Funding dollars buy staff, measured in standardized Full-Time Equivalent Hours (FTEs). Staff may perform client-related and organization related functions. Client-related activities, performed by services staff, enables client outcomes which is the purpose of service. The lower the cost per services staff FTE, the higher the ratio of service to administrative staff. Available service staff FTEs multiplied by the average number of hours of worktime of services staff determines the hours of Available Service Time (AST). Service Capacity 122 in human services may be the rate of funding conversion, measured in the cost per services staff FTE, or the cost per AST. For example, if a company receives $1,000,000 in funding and employs 10 FTEs of staff, the cost per FTE is $100,000. If the ratio of services to all staff is 70%, there are 7 FTEs of services staff, and the cost per services staff FTE is $142,857. If the cost per FTE remains the same in the next period, but the ratio of services to all staff increases 14.29% to 80%, then the cost per services staff FTE decreases by 12.5% to $125,000. Improvement in the efficiency of the conversion of funding to staffing services increases available service time and the opportunity for helping more people change their lives.

Effort may involve applying available service time to serve clients, helping them achieve their goals. Service staff perform client-related activities that are direct and non-direct in working with clients to enable them to achieve the changes in their condition that they seek. Non-direct service activities may include such things as case recording, case supervision, staff travel, case consultation and service coordination where services staff are not working directly with the client. Client Service Time (CST) may be the time, in hours, that services staff spend working directly with clients. Effort is the ratio of client service time (CST) to the available service time (AST) in the current inventory of services staff. The higher the ratio of CST to AST, the lower the cost per hour of CST.

For example, if services staff cost $142,857 per FTE and an FTE, on average, represents 1,505 workhours per FTE-year, then available service time is $94.92 per AST hour. If, in addition, the ratio of CST to AST is 20%, the cost per CST hour is $474.61. If the cost per services staff FTE remains the same in the next period along with the average annual hours of work, but the ratio of CST to AST increases by 50% to 30%, the cost per CST hour decreases by 33% to $316.41. Improvement in the efficiency of use of the inventory of services staff time (AST) in helping clients achieve the changes they seek may increase client service time and reduce the cost per CST hour.

Effect may involve enabling client goal achievements with the provision of client services. Services staff have different skills and experience and have different rates of success helping clients achieve different goals. For example, some are better in supportive roles, others in intervention roles. Improving the pairing of client goals with available staff skills, in turn, improves the rate of clients achieving their goals. As above, the skills and experience of the services staff may be included in the staff information 326. Portions of the staff information 326 may be stored on the performance technology system 300 in a staff profile. As above, in some embodiments, the performance technology system 300 may recommend the staff to the client based on the staff information 326 and the client information 312. In some deployments, case managers may match and assign services staff.

The more effective the client services rendered, the more clients achieve outcomes with each hour of client service time. Effect is the ratio of changes in client condition (CICCs) to CST hours. The higher the ratio, the lower the cost per CICC. For example, if 100 hours of CST enables 7 changes in client condition (CICCs), and CST costs $474.61 per hour, then CICCs cost $6,780.14. If Effect improves from 7 to 9 CICCs per 100 hours of CST, and CST cost remains $474.61, then CICC cost decreases by 22.2% to $5,273.44. Improvement in the efficiency of use of CST in helping clients achieve the changes they seek increases the Effect of services and reduces the cost per CICC.

As above, the service information 316 may include services rendered information 317, progress information 318 and outcome information 319. The services rendered information 317 may be information that is entered after each session with clients to give an overview of actual service and information about that service. The performance technology system 300 may be configured to calculate baseline measures based on at least the base information 325, compare the baseline measures to measured service performance of the company in a current period. The base information 325 may be input into the performance technology system 300 on install of the same. Further, the outcome information 319 may be compared with the base information 325 to determine a base cost per outcome. Further, the outcome information 319 may be compared with the services rendered information 317 to determine a current cost per outcome. The performance technology system 300 may perform this step automatically. Preferably, the services rendered information 317 may include AST and CST hours in the current period. The outcome information 319 may include the CICCs. For example, at each session the staff or case manager may record progress (progress information 318) and outcomes or partially completed outcomes (outcome information) 319.

The performance technology (or processor 330) may then selectively generate at least one report illustrating service performance of the company in a selected period as tangible data, as shown in FIGS. 8-10. This step may be actuated by a member of the company such as staff, case managers, etc. For example, a case manager may want to view Service Capacity of 2019 as compared to 2018. The performance technology system 300 may provide the reports as viewable or downloadable files.

As above, the base information 325 may include financial information 327 such as current and previous period funding of the company. Changes in funding and operating surpluses or deficits happen in every company, including human services companies. Every human service company has a baseline cost per FTE, CST hour, and CICC. That baseline cost reflects the baseline rate of the predetermined key performance indicators 120: Service Capacity, Effort and Effect. With funding of $1 million, staffing of 10 FTEs, and a baseline ratio of services to all staff of 70%, the company's cost per services staff FTE is $142,857. Similarly, with a baseline of 1,505 available service hours per FTE year, and a ratio of 20% CST to AST, the cost per CST hour, is $474.61, and with a baseline ratio of 7 CICCs per 100 hours of CST, the cost per CICC, is $6,780.14. Changes in funding change the number of FTEs, CST hours and CICCs, at best, directly and proportionately. Assuming the productivity ratios of Service Capacity, Effort and Effect remain the same, a 50% increase in funding should yield 50% more FTEs, CST hours and CICCs.

For example, if a company receives $1,000,000 in funding, employing 7 services staff FTEs, delivering 2,107 hours of CST, enabling 147.49 CICCs, and funding increases 50% to $1,500,000 with no change in productivity, the company should employ 10.5 services staff FTEs, delivering 3,160.5 hours of CST, enabling 221.24 CICCs. With 50% more funding, the company employs services staff FTEs at $142,857, delivers CST at $474.61, and enables CICCs at $6,780.14. There is no increase in efficiency, simply greater spending on services. Productivity changes alone reduce output and outcome costs, adding value to human services.

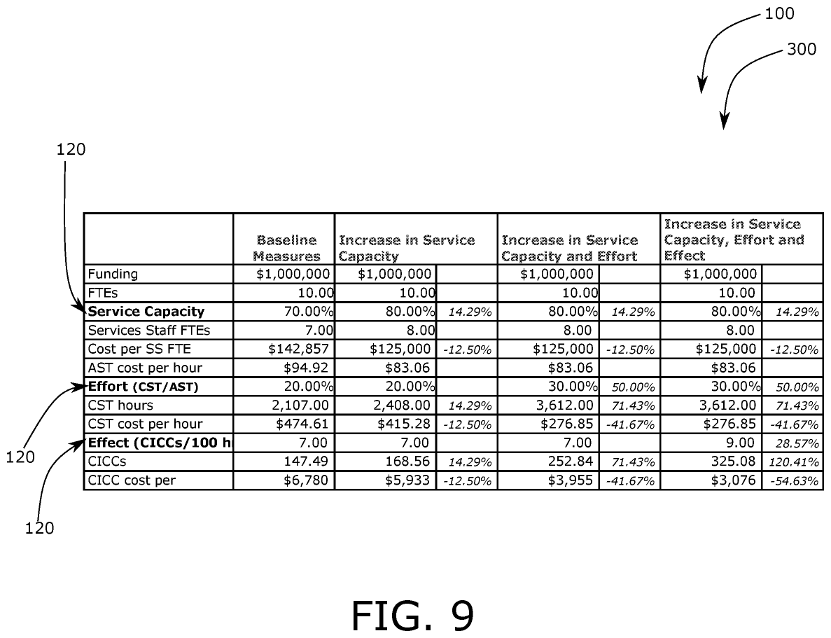

Human service companies convert funding into changes in client condition, or outcomes. Improvements in the efficiency of use of resources in core business processes may increase the predetermined key performance indicators 120—Service Capacity, Effort and Effect 126. By making changes in the use of resources in service delivery, human service companies may increase the RoSI, increasing client benefits from service, with available funding. The three core business processes of human service companies, converting funding, applying staff time, and effecting client changes may be interdependent. Companies may make changes in their use of resources to increase available service time, or to apply more available service time to client services, or to effect more client changes with services provided, or any combination of the three core service delivery processes. A company may make changes in all three to double the impact of their services with clients, as illustrated in FIG. 9.

In this example, funding remains $1 million and the company employs 10 staff. The “Baseline Measures” column on the left of the table lists the same baseline measures outlined, earlier, including funding of $1 million, 70% Service Capacity, Effort at 20%, etc. The first column to the right of Baseline Measures lists changes that occur with a singular increase in Service Capacity, from a baseline 70% to 80%. The increase in Service Capacity from 70% to 80% is a 14.29% increase, with a corresponding decrease in the unit cost of services staff FTEs of 12.5%. With no change in Effort, the number of CST hours increases by 14.29%, with a corresponding decrease in the unit cost of CST of 12.5%. Similarly, with no change in Effect, the increase in Service Capacity increases the number of CICCs by 14.29%, with a decrease in unit cost of 12.5%. An increase in Service Capacity has a corresponding effect upon CST and CICCs, when Effort and Effect remain unchanged.

The next column to the right in FIG. 9 shows an increase in both Service Capacity and Effort. Service Capacity increases by 14.29%, as before, with a decrease in unit cost of 12.5%. A 50% increase in Effort, however, shows a 71.43% increase in CST hours and a corresponding decrease in unit cost of 41.67%. The increase in CST is a function of both the increase in the rate of Service Capacity and the rate of Effort. Similarly, these two productivity changes increase the number of CICCs by 71,43%, reducing their unit cost by 41.67%.

The last column to the right shows a combination of increases in Service Capacity, Effort, and Effect—three changes in service productivity resulting from changes in the use of resources in core service delivery processes of a company. Again, the Service Capacity increase of 14.29% combines with the increase in Effort of 50%, and, now, an increase in Effect of 28.57% to generate 120.41% more CICCs. Companies can work on multiple changes in the efficiency of service delivery processes at any time to double the impact of their services with clients. Further, by monitoring changes in these predetermined key performance indicators 120, company managers can identify the source(s) of changes in their RoSi. Using productivity analytics, human service companies can manage the impact of their services with clients from period to period.

The performance technology system 300 may enable service providers to increase the supply of human services with available funding, saving on services. More efficient service delivery processes save money, and changes in the RoSi reflect changes in the efficiency of service delivery processes. When funding was increased, above, from $1 to $2 million, with no change in Service Capacity, Effort or Effect, RoSI remained the same at 100 outcomes per $1 million in funding. With no change in RoSI, added value (VoS) was $0 per $1 million, and return on service (RoS) was 0¢ per $1 of funding.

Three changes in the productivity of services were outlined above. In the first, Service Capacity increased by 14.29%, increasing RoSI by 14.29%, from a baseline measure of 147.49 CICCs per $1 million in funding, to 168.56 CICCs per $1 million. This singular performance improvement added $142,900 in value per $1 million in funding, or return on service (RoS) of 14.29¢ per $1 of funding. In the second change, Service Capacity increased by 14.29%, and Effort increased by 50%, increasing RoSI by 71.43%, from a baseline of 147.49 CICCs per $1 million to 252.84 CICCs per $1 million in funding. This dual improvement added value to service of $714,300 per $1 million in funding, and created a RoS of 71.43¢ per $1 of funding. In the third change, Service Capacity increased by 14.29%, Effort increased by 50%, and Effect increased by 28.57%, increasing RoSI by 120.41% over baseline.

This triple change in the productivity of service delivery processes added value to service of $1.2 million per $1 million in funding, and created a RoS of 120¢ per $1 in funding. The cumulative effect of three fractional changes in the efficiency of use of resources in service delivery has more than doubled the impact of company services. A RoS of 120¢ per $1 means that the impact of funding has more than doubled, and the increase in client outcomes achieved with available funding has saved the funder $1.20 per $1 of funding in additional client outcomes that the funder has not had to pay for.

It should be noted that the methods may include optional steps and may not be implemented in all cases. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for improving efficiency of services provided by a company are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A method for measuring service performance of a company, the method comprising the steps of:
providing a performance technology system including at least one memory and at least one processor, the at least one memory including at least one database;
receiving base information, the base information including at least:
staff information; and
financial information;
receiving client information gathered from at least one client, the client information including at least:
need information;
goal information; and
barrier information;
determining at least one service plan for the at least one client;
generating at least one client profile for the at least one client;
receiving service information at predetermined intervals, the service information including at least:
services rendered information;
progress information; and
outcome information;
calculating baseline measures based on at least the base information;
comparing at least the service information with the baseline measures;
measuring service performance of the company in a current period based on comparison of the at least said service information with the baseline measures; and
selectively generating at least one report illustrating service performance of the company in a selected period as tangible data.

2. The method of claim 1, wherein the service performance is measured relative to at least three key performance indicators.

3. The method of claim 1, wherein the outcome information includes an outcome in the service plan of the at least one client.

4. The method of claim 3, wherein at least a portion of the outcome information is compared with at least a portion of the base information to determine a base cost per outcome.

5. The method of claim 4, wherein said at least said portion of the outcome information is compared with at least a portion of the services rendered information to determine a current cost per outcome.

6. The method of claim 5, wherein said at least said portion of the outcome information is combined with said at least said portion of the base information to determine a baseline rate of service impact.

7. The method of claim 6, wherein said at least said portion of the outcome information is combined with said at least said portion of the services rendered information to determine a current rate of service impact.

8. The method of claim 1, wherein at least one of the base information, client information and service information includes standardized scores and standardized phrases.

9. The method of claim 1, wherein the staff information is compared with the client information, and a staff member is recommended for the service plan based on comparison of the staff information with the client information.

10. The method of claim 1, wherein the performance technology system is accessible via an electronic device, and wherein the at least one database is viewable on the electronic device.

11. The method of claim 10, wherein the at least one client is a plurality of clients, wherein each of the plurality of clients has a client profile, wherein each said client profile is stored on at the at least one database, and wherein each said client profile is viewable on the electronic device.

12. A performance technology system used for measuring service performance of a company, the performance technology system comprising:
providing a performance technology system, the performance technology system being accessible via an electronic device, including:
at least one memory including at least one database, the database being viewable on the electronic device; and
at least one processor, the at least one processor configured to:
receive base information, the base information including at least:
staff information; and
financial information;
receive client information gathered from at least one client, the client information including at least:
need information;
goal information; and
barrier information;
determine at least one service plan for the at least one client;
generate at least one client profile for the at least one client;
receive service information at predetermined intervals, the service information including at least:
services rendered information;
progress information; and
outcome information;
calculate baseline measures based on at least the base information;
compare at least the service information with the baseline measures;
measuring service performance of the company in a current period based on comparison of the at least said service information with the baseline measures; and
selectively generating at least one report illustrating service performance of the company in a selected period as tangible data.

13. The method of claim 12, wherein the service performance is measured relative to at least three key performance indicators.

14. The method of claim 12, wherein the outcome information includes an outcome in the service plan of the at least one client.

15. The method of claim 14, wherein at least a portion of the outcome information is compared with at least a portion of the base information to determine a base cost per outcome, and wherein said at least said portion of the outcome information is compared with at least a portion of the services rendered information to determine a current cost per outcome.

16. The method of claim 15, wherein said at least said portion of the outcome information is combined with said at least said portion of the base information to determine a baseline Rate of Service Impact, and wherein said at least said portion of the outcome information is combined with said at least said portion of the services rendered information to determine a current Rate of Service Impact.

17. The method of claim 12, wherein at least one of the base information, client information and service information includes standardized scores and standardized phrases.

18. The method of claim 12, wherein the staff information is compared with the client information, and a staff member is recommended for the service plan based on comparison of the staff information with the client information.

19. The method of claim 12, wherein the at least one client is a plurality of clients, wherein each of the plurality of clients has a client profile, wherein each said client profile is stored on at the at least one database, and wherein each said client profile is viewable on the electronic device.

20. A method of measuring service performance of a human services company, the method comprising the steps of:
providing a performance technology system including at least one memory and at least one processor, the at least one memory including at least one database, the performance technology system being accessible via an electronic device, and wherein the at least one database is viewable on the electronic device;
receiving base information, the base information including at least:
staff information; and
financial information;
receiving client information gathered from a plurality of clients, the client information including at least:
need information;
goal information; and
barrier information;
determining at least one service plan for the plurality of clients;
generating a client profile for each of the plurality of clients, the client profile being stored on the at least one database and viewable on the electronic device;
receiving service information at predetermined intervals, the service information including at least:
services rendered information;
progress information; and
outcome information, the outcome information including an outcome in the service plan of the at least one client;
calculating baseline measures based on at least the base information;
comparing at least the service information with the baseline measures;
measuring service performance of the company in a current period based on comparison of the at least said service information with the baseline measures, and relative to at least three key performance indicators; and
selectively generating at least one report illustrating service performance of the company in a selected period as tangible data; and
wherein at least a portion of the outcome information is compared with at least a portion of the base information to determine a base cost per outcome;
wherein said at least said portion of the outcome information is compared with at least a portion of the services rendered information to determine a current cost per outcome;
wherein said at least said portion of the outcome information is combined with said at least said portion of the base information to determine a baseline rate of service impact;
wherein said at least said portion of the outcome information is combined with said at least said portion of the services rendered information to determine a current rate of service impact;
wherein at least one of the base information, client information and service information includes standardized scores and standardized phrases; and
wherein the staff information is compared with the client information, and a staff member is recommended for the service plan based on comparison of the staff information with the client information.
